(19) United States
(12) Patent Application Publication
(10) Pub. No.: US 2011/0074304 A1
(43) Pub. Date: Mar. 31, 2011

(54) WIRELESSLY SUPPLIED ILLUMINATION MEANS

(75) Inventors: Martin Honsberg-Riedl, Teisendorf (DE); Wolfgang Pabst, Deisenhofen (DE); Robert Kraus, Regensburg (DE)

(73) Assignee: OSRAM GESELLSCHAFT MIT BESCHRAENKTER HAFTUNG, Muenchen (DE)

(21) Appl. No.: 12/994,154

(22) PCT Filed: May 19, 2009
(86) PCT No.: PCT/EP2009/003557

§ 371 Date: Nov. 23, 2010

(30) Foreign Application Priority Data
May 23, 2008 (DE) 10 2008 024 780.4

(51) Int. Cl. H05B 41/24

(52) U.S. Cl. 315/250

(57) ABSTRACT

An illuminator may include at least one receiver configured to wirelessly tapping off power from an alternating field; and at least one light source which is connected to the receiver, wherein the illuminator has a flat adhesive surface which is magnetic or can be magnetized.

The invention relates to an illumination means, in particular a self-adhesive LED lamp, and to an illumination means mount having an attachment surface for attachment of the illumination means.

In recent years, a range of greatly improved light-emitting diodes, LEDs, with a considerably greater light flux have been developed and marketed. Particularly in the case of light-emitting diodes, in their lighting applications, generally luminaires of a traditionally conventional design, LEDs have hitherto been electrically supplied by wires or via board contacts. Larger LEDs are frequently delivered on a small (hexagonal) metal-core board with half-open screw eyes (for example from OSRAM, type: OSTAR LEW E3A), which can be connected in a type of socket. Normally, LEDs constructed in this way are screwed onto cooling surfaces and are connected by wire or by means similar to wires (spring contacts). Sockets, which are more suitable for general illumination LEDs, have not yet been standardized. Known sockets from the field of incandescent lamps are therefore generally used nowadays (Retrofit), although these sockets are not optimally designed, for example, for heat dissipation, are space-consuming, and the lamps must be fitted at a defined point.

WO 2007/008646 A2 discloses a general apparatus for transmission of electromagnetic power, which has a first resonator structure which receives power from an external power supply. The first resonator structure has a first Q-factor. A second resonator structure is positioned distally from the first resonator structure and produces an operating current for an external load. The second resonator structure has a second Q-factor.

The distance between the two resonators may be greater than the characteristic size of each resonator. Non-radiating power transmission between the first resonator structure and the second resonator structure is achieved by coupling their evanescent resonance-field profile.

US 2005/0104453 A1 discloses a general apparatus for wireless power transmission including a mechanism for receiving a radiofrequency range via an accumulation of frequencies. The apparatus has a mechanism for conversion of the radio radiation over the accumulation of frequencies to a DC voltage, preferably at the same time. One method for wireless power supply includes the following steps: reception of a range of radio radiation over an accumulation of frequencies and conversion of the radio radiation over the accumulation of frequencies to a DC voltage, preferably at the same time.

The object of the present invention is to provide a capability for attachment for illumination modules or illumination means, in particular LED illumination means, which offers spatially flexible arrangement, can be installed easily, and is preferably space-saving.

This object is achieved by an illumination means, an illumination means mount and a system including an illumination means mount and an illumination means, as claimed in the respective independent claim. Preferred embodiments are specified, in particular, in the dependent claims.

The illumination means has at least one receiver for wirelessly tapping off power from an alternating field, in particular at least a magnetic alternating field, and at least one light source which is connected to the receiver for tapping off electrical current. The alternating field may be a magnetic field, for example in the case of transformer (inductive) coupling, but may also have electrical components, which may or may not be used.

Since there is no galvanic electrical connection, the space which is normally required for a galvanic contact can be saved but, instead of this, a smaller amount of additional space is required for the receiver. As a result of the lack of physical contact, the illumination means or illumination module can furthermore be arranged largely freely and easily. A further advantage is that a lighting problem can also be solved in a special environment (for example under water or in an area which cannot be touched, is at risk of corrosion and/or where there is an explosion hazard).

The receiver preferably has at least one coil which produces a corresponding voltage, which can be tapped off, in a magnetic alternating field.

In one refinement, the at least one light source can tap the electrical current required for its operation off directly via the at least one coil.

In another refinement, the receiver may have a resonant circuit, in particular an LC resonant circuit. A resonant circuit typically has an associated resonant frequency at which the power output is particularly high.

The resonant circuit can be equipped with an antenna for better power reception, possibly according to US 2005/0104453 A1.

In one refinement, the at least one light source can be electrically connected to the resonant circuit via an inductive or capacitive tap.

According to one refinement, the illumination means has at least one light-emitting diode, which emits white or colored light, as a light source, in particular at least one LED chip, which emits white or colored light and is mounted on a submount. In principle other types of light sources are admittedly feasible in the above illumination means, but LEDs are particularly highly suitable for illumination means, in particular mobile illumination means. By way of example, LEDs have the particular advantage that both high efficiency of the light source and the color temperature are largely maintained even in the case of a partial supply (dimming). In addition, starting processes, such as those in the case of discharge lamps, or threshold power levels, such as those in the case of incandescent lamps, in practice do not occur with LEDs. In addition, no problems need be expected with burning hazards or high voltage when LED illumination means are handled manually, and a lighting system such as this is highly safe. Furthermore, no wiring service is required.

In one refinement, the illumination means has at least two diodes connected back-to-back in parallel, at least one of which is a light-emitting diode. The other light-emitting diode may likewise be a light-emitting diode or else, for example, a diode which does not emit light, such as a Schottky diode. It is also possible to connect further diodes, in particular light-emitting diodes. In general, it is also possible to use a single light-emitting diode.

However, it may also be advantageous for integration of elements which are operated with a DC voltage for the receiving means to be followed by a rectifier in order to convert AC voltage, produced by the receiving means, to a DC voltage, for example a full-bridge or half-bridge rectifier.

In a further refinement, a logic circuit can be provided, for example an integrated circuit such as a microcontroller, for example of the Texas Instruments MSP 430 type. This allows the illumination means to be equipped with intelligence in order to allow particularly flexible operation; the light sources can for this purpose be controlled by the microcontroller. In order to maintain the supply voltage for the logic circuit at an adequate voltage level for a sufficient time, it is preferable for the logic circuit to be preceded by a DC voltage energy store, in particular at least one high-energy-density capacitor, such as a double-layer capacitor, also referred to as electro-chemical double-layer capacitors (EDLC) or supercapacitors, which are commercially available, for example, under the brand name Goldcap, Supercap, BoostCap or Ultracap. These double-layer capacitors have the greatest energy density of all capacitors.

The logic circuit is advantageously designed to read data transmitted by means of the alternating field. The data can be modulated onto the carrier for example by means of ASK (Amplitude Shift Keying; amplitude modulation), PSK (Phase Shift Keying; amplitude modulation), FSK (Frequency Shift Keying; frequency modulation) or mixed forms thereof, and can be extracted again at the illumination means. By way of example, the data can predetermine a setting of the light intensity by the microcontroller.

In a further refinement, the illumination means may be self-adhesive. For this purpose, it typically has an adhesive contact for a suitable mount.

The adhesive contact is preferably provided over an area, in order to assist good heat dissipation via the contact. The adhesive surface may therefore, in particular, be in the form of a planar contact surface, in particular for contact with an areal, in particular planar, attachment surface.

The adhesive contact of the illumination means may be in various forms, for example by means of a clamping tab (for example similar to studded children's toy building blocks), a Velcro material or an adhesive such as an adhesive silicone. However, it is particularly preferable for the illumination means to have an adhesive surface which is magnetic or can be magnetized. Magnetic adhesion has the advantage that the illumination means can easily be rotated, for example by sliding or by lifting off and placing the illumination means down again. Furthermore, it is highly space-saving. The illumination means can be positioned freely on a base with an adhesive effect.

However, if the illumination means is to be fitted in a socket, it is preferable to use a socket with a short thread or a bayonet fitting, thus allowing comparatively quick fitting and removal.

In general, but in particular linked to the characteristic of the illumination means being able to rotate, an illumination means is preferred in which the receiver is sensitive to one direction of the field which is applied to it and is at least magnetic. This allows an efficiency of the power tap to be adjusted by rotating the illumination means in the alternating field. In particular, this allows the brightness of the illumination means to be adjusted, or even switched off. Typically, a rotation through about 90° is carried out in order to vary the power transmission between maximum power which can be tapped off and not allowing any significant power to be tapped off.

In one refinement, the illumination means can be encapsulated in a protective housing, in particular accommodated completely, in which case the housing is preferably permeable for the feed field. Alternatively, the receiver or a part of it, for example, an antenna or a coil, can be attached to an outer face, for example by printing on.

The illumination means mount is equipped with an attachment surface for attachment of an illumination means, wherein the illumination means mount has at least one transmitter for emission of an alternating field through the attachment surface. This results in a fed area being produced on the attachment surface. If a suitable illumination means is attached to the attachment surface, then it can use the feed field produced in this way to tap off power. The power is therefore transmitted via a local at least magnetic alternating field through the holding attachment surface, which may be planar or else curved, to illumination means which can be fitted relatively freely.

The illumination means are preferably supplied with power wirelessly only on and close to the attachment surface, for example up to a distance of 5 cm, in order to prevent electromagnetic interference in the further area. This means that a distance between the receiver of an illumination means and a surface area being fed preferably does not exceed 5 cm, and particularly preferably does not exceed 3 cm.

In one refinement, the illumination means mount has a plurality of transmitters which are distributed over a flat area and, in particular, are arranged substantially parallel to the attachment surface. By way of example, the transmitters can be arranged in the form of a matrix or strip. Alternatively, the transmitter may be in the form of a flat areal transmitter, for example based on polymer films.

In order to broaden the emission area, the transmitter may also have a plurality of coils, in particular a plurality of coils connected in series and distributed laterally.

In one refinement, the entire attachment surface can be fed by the transmitters. It is preferable, for example in order to reduce the power consumption or to switch the illumination means off without rotating them, for the illumination means mount to be designed such that its attachment surface has at least one area which is fed by the at least one transmitter, and at least one area which is not fed. There are preferably points or areas fed in a close grid and points or areas which are not fed on the attachment surface.

Adjacent transmitters are preferably separated from one another by a distance of no more than 10 cm.

The at least one transmitter is preferably arranged at a distance of no more than 1 cm below the attachment surface.

It is also preferable for the at least one transmitter to have a resonant circuit, in particular if the illumination means are equipped with a resonant circuit for tapping power off from the alternating field.

In one refinement, the frequency of the at least one transmitter is tunable. The transmitter therefore has a twin-division multiplexing capability for illumination means which are fed at a different frequency.

The transmitter can preferably be tuned in a frequency range between 100 KHz and 100 MHz, in particular between 100 KHz and 5 MHz.

In order to mechanically adjust the amount of energy transferred to an illumination means, it may be preferable for the at least one transmitter to emit a directed alternating field. This can be achieved, for example, by using a coil with a linear coil core.

An illumination means mount is particularly preferable which has at least one, in particular flexible, magnetic film whose magnetic surface represents the attachment surface. In one refinement, a plurality of magnetic films can also be joined together in order to produce a larger attachment surface. The magnetic film can thus be extended in a preferred manner. A magnetic film with a polymer matrix is preferred.

One surprising characteristic of the flexible magnetic film is that it does not produce a shielding effect for electromagnetic radio-frequency fields, for example at a frequency of 500 KHz. The supply of the illumination means by local radio-frequency fields is therefore not impeded. Even complete cladding of the attachment surface with flexible magnetic film is therefore possible.

Furthermore, the magnetic film allows virtually any desired placing of the illumination means, and is virtually insensitive to dirt.

A commercially available flexible magnetic film with a material thickness of, for example, 1.68 mm develops weakly adequate holding forces with respect to ferrite material, strong holding forces with respect to adhesion magnets or a physically identical flexible magnetic film, and is therefore very highly suitable for use as a material for the attachment surface. The magnetic film therefore preferably has a thickness of 1 mm to 2.5 mm, in order to achieve a low weight and flexibility with adequate adhesion performance at the same time.

The at least one transmitter is then preferably fitted to a surface of the magnetic film opposite the attachment surface.

The system or lighting system has at least an illumination means mount as described above and at least one illumination means as described above.

In one refinement, the system or lighting system has at least one illumination means mount, wherein the frequency of the at least one transmitter is tunable, and at least two illumination means, in which the respective receiver has at least one, and in particular one and only one, resonant circuit, with one of the two illumination means having a resonant circuit with a first resonance frequency, and the other of the two illumination means having a resonant circuit with a second resonance frequency, with the first resonance frequency and the second resonance frequency being different. It is therefore possible to operate the illumination means selectively as a function of their resonance frequency by tuning the transmitter or the transmitters. A specific group of illumination means with a first characteristic, for example a first color, can thus have the same resonance frequency, and another group of illumination means with a second characteristic, for example a second color, may have a different resonance frequency. Illumination means are preferred whose resonance frequency is color-selective, that is to say illumination means of the same color have the same resonance frequencies, for example four groups of different resonance frequencies for the colors red, green, blue and white. In particular, the use of modules or illumination means with red, green, blue and/or white LEDs makes it possible for the user to quickly manually set both highly colored and white light situations. In general, the feeding of all the illumination means on one attachment surface can preferably be adjusted on a group-selective basis, thus making it possible, for example, to completely switch off one or more colors.

The number of groups is limited only by the resolution of the control process, that is to say the different resonance frequencies must be located sufficiently far apart from one another that they can be driven separately. By way of example, the width of a resonance peak is in the region of 10% of the frequency band between 100 KHz and 600 KHz, as a result of which a possible frequency separation is, for example, at least 50 KHz.

Selective access to illumination means groups is particularly advantageous for externally controlled, possibly automatic, effects (for example color tone changes) or for light figures (for example changing pointers). The illumination means mount is for this purpose preferably equipped with or connected to an appropriate drive which, particularly preferably, has a control section for setting lighting characteristics, for example a dim toggle or dim slide, a color selection control element, etc.

In one refinement, the power can be transmitted from the at least one transmitter of the illumination means mount to the receiver of the at least one illumination means by transformer coupling, and this may have a high efficiency particularly when good coupling is selected between the transmitter and receiver.

It may also be preferable for the power to be transmitted from the at least one transmitter of the illumination means mount to the receiver of the at least one illumination means by resonant coupling. The resonant coupling of two resonant circuits, in particular with a relatively high quality, is particularly preferable since this allows (electro)magnetic energy to be transmitted with considerably lower coupling factors than in the case of transformer power transmission, and the air gap can be widened from the millimetric range to the centrometric range. This has an advantageous effect on the feasibility of attachment surfaces fed with magnetic fields. Nevertheless, the RF radiated emission still remains very low, as a result of which it can still be considered to be a local field.

The individual illumination means can generally preferably be placed in self-adhesive manner, and at any given point there, on the attachment surface of the illumination means mount. For this purpose, a system having an illumination means mount with a magnetic film and having at least one illumination means with an adhesion means which can be magnetized or is magnetic, for example a permanent magnet, is particularly preferable.

It is also preferable for the strength of a power transmission from the illumination means mount to at least one of the illumination means to be adjustable (dimmable) by a relative rotation of the illumination means on the illumination means mount between a maximum value and essentially zero. The dimming capability may be of particular interest for configuration of specific light figures, since dimming by movement at points where there is no feed would scarcely then be feasible. Furthermore, a “rotating knob function” is generally popular.

It is generally preferable for manual adjustment of the brightness of the illumination means to be possible by its rotation or linear movement in the direction of points where there is no feed on the attachment surface.

The adhesion of the illumination means on the attachment surface should preferably be sufficiently good that it results in a dissipating cooling path, which can dissipate the majority of the heat losses from the light sources (preferably LEDs) and possible upstream electronics.

The system is intended in particular for general lighting and for decorative lighting.

The invention will be described schematically and in more detail with reference to exemplary embodiments in the following figures. In this case, identical elements or elements having the same effect may be provided with the same reference symbols, in order to assist understanding.

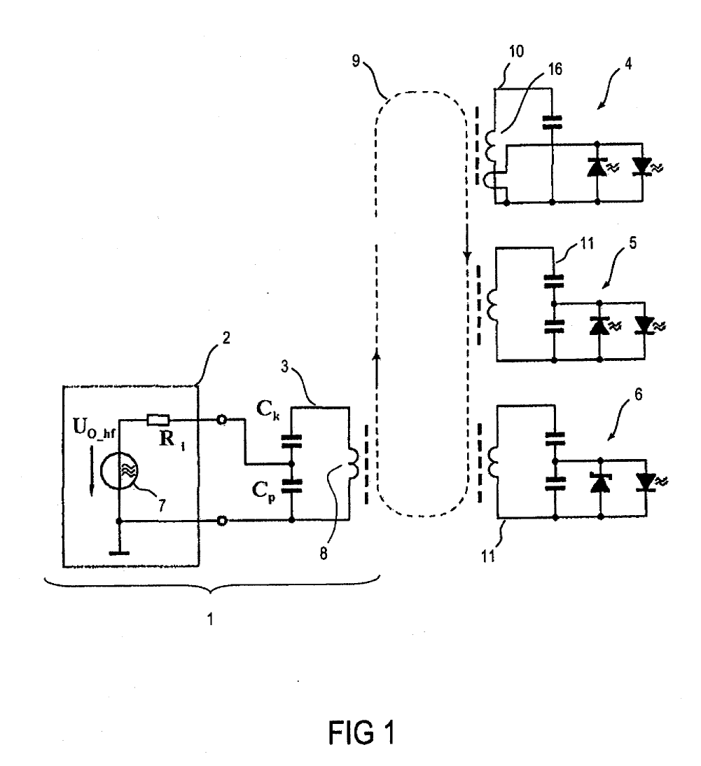

FIG. 1 shows a circuit diagram of a system comprising an illumination means mount and three illumination means by way of example;

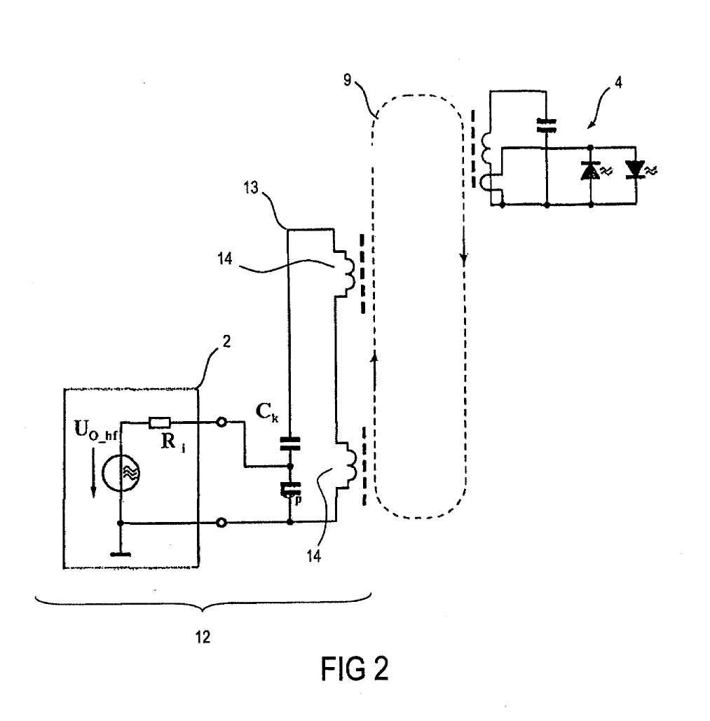

FIG. 2 shows a circuit diagram of a system comprising a further illumination means mount and an illumination means;

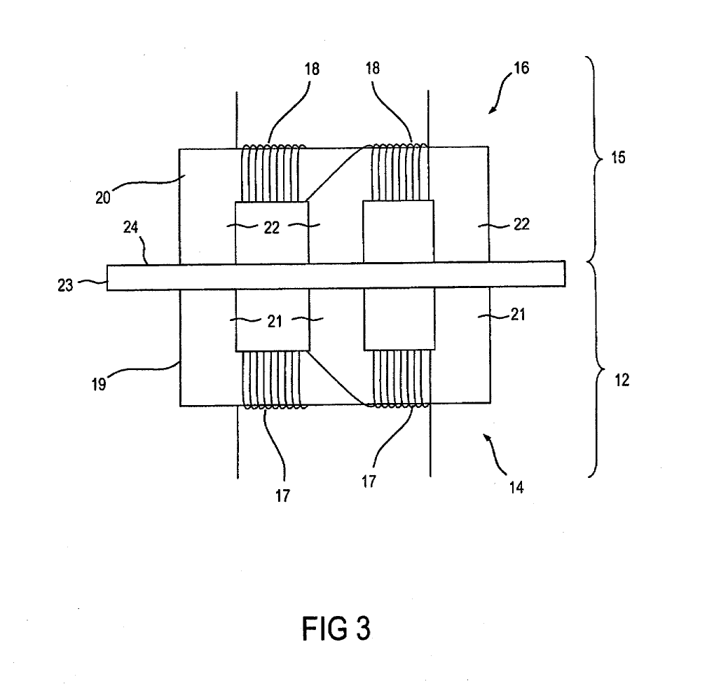

FIG. 3 shows a side view of a simplified sketch of a further lighting system in the form of a detail;

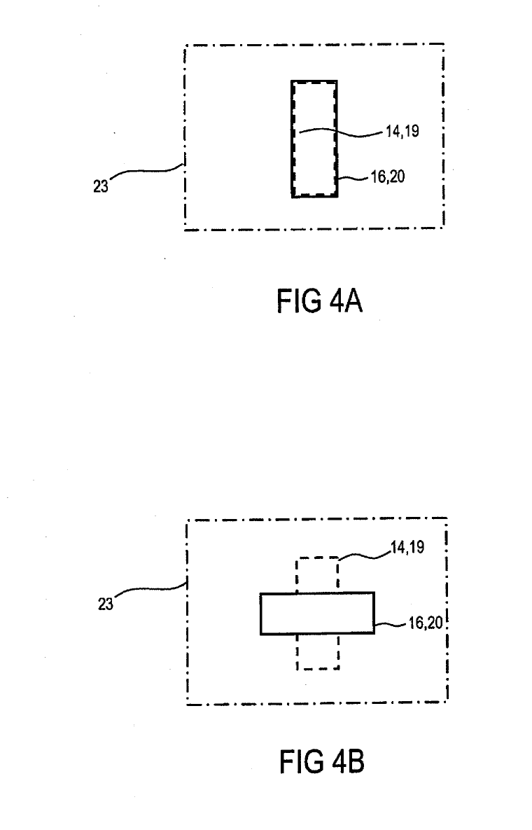

FIG. 4 shows a plan view of a sketch of the simplified system shown in FIG. 3, in the form of two sub-images with the illumination means at the maximum power transmission position (FIG. 4A) and in the minimum power transmission position (FIG. 4B).

FIG. 1 shows a circuit diagram of a system including an illumination means mount 1 with a resonant feed circuit 2 as a transmitter, which is operated from a radio-frequency source generator 3, and three illumination means by way of example (also referred to as illumination modules) 4, 5, 6.

The radio-frequency source generator 3 produces a radio-frequency AC voltage signal which is fed into the resonant feed circuit or feeding resonant circuit 2.

The resonant feed circuit 2 has two capacitors Ck and Cp and a coil 8, as shown, wherein the radio-frequency signal is introduced via the capacitor Cp. A corresponding radio-frequency magnetic field 9 is produced by the coil 8, by means of the AC voltage signal.

The illumination means 4, 5, 6 each have a resonant circuit 10, 11 as a receiver. In detail, the first illumination means 4 has a resonant circuit 10 with a coil 16 and a capacitor (without any reference symbol), wherein the resonant circuit has a predetermined resonance frequency. When the RF magnetic field 9 is oscillating at the resonance frequency or close to the resonance frequency, the resonant circuit 10 is excited particularly strongly, which allows a power which is high in comparison to non-resonant excitation to be tapped off from the resonant circuit 10. These considerations are also applicable to the resonant circuit 11 of the illumination means 5 and 6. In the first resonant circuit 10, the power is tapped off by means of an inductive tap from two light-emitting diodes (without any reference symbols), which are connected back-to-back in parallel, for the operation thereof. The light-emitting diodes light up alternately while current is flowing in their respective forward-biased direction. The second illumination means 4 has a resonant circuit 11 with a coil and two capacitors (without reference symbols). In the second resonant circuit 11, the power is tapped off by means of a capacitive tap via one of the capacitors, likewise from two light-emitting diodes (without reference symbols) which are connected back-to-back in parallel, for operation thereof. In this case, the light-emitting diodes also light up alternately while current is flowing in their respective forward-biased direction. The third illumination means 6 has a Schottky diode instead of one of the light-emitting diodes in comparison to the second illumination means 5. The light-emitting diode lights up only while current is flowing in its respective forward-biased direction, although this is not perceived by the eye because of the high frequency of the direction change.

The feed via the resonant coupling operates, for the illustrated exemplary embodiment, only in a limited frequency range which, from experience, is about 10% of the carrier frequency used for the AC voltage signal (for example +/−25 KHz for a 500 KHz carrier). A time-division multiplexing process can now be implemented in which different carrier frequencies are fed in a time sequence and are in each case received separately at resonance by associated illumination means (for example groups of different colors or of different arrangement). The respective groups can thus be driven separately. The time sequence is chosen such that the eye perceives the illumination of the diode or diodes as being continuous, without flickering. The illumination means may all have the same fundamental design, with different dimensions of the oscillation components.

Alternatively, for example, transformer coupling is also feasible.

FIG. 2 shows a system similar to that shown in

FIG. 1, in which the illumination means mount 12 now has a resonant circuit 13 with two series-connected coils 14. The two coils 14 have fewer windings than the coil 8 shown in FIG. 1, in order to maintain the oscillation behavior of the resonant circuit 13. The two coils 14 can also be in the form of a double coil with two separate windings on one common core. This arrangement increases the lateral extent of the RF magnetic field 9 (upward for the illustrated figure), thus providing a larger feed area for the illumination means 4, with an adequate light intensity.

FIG. 3 shows a side view of a simplified physical representation of a system with the illumination means mount 12 from FIG. 2, of which the double coil 14 is illustrated here, and an illumination means 15, of which a double coil 16 is shown. This makes it possible to increase the lateral offset which is still permitted. The illumination means 15 may otherwise, for example, be designed analogously to the illumination means 4, 5 or 6 from FIG. 1. The coils 14, 16 both have two windings 17 and 18, which are wound around an “E”-shaped core 19 and 20, to be more precise each of the windings 17, 18 is wound around a section of the respective core 19 or 20 which does not have a leg 21 or 22, respectively, of the “E”.

The core 19 of the coil 14 is fitted with the end surfaces of the legs 21 on a rear face of a 1.68 mm thick flexible magnetic film with a polymer matrix 23.

Since the core 20 of the coil 16 is composed of a ferromagnetic material, its legs 20 magnetically adhere with a high adhesion force to the front face of the magnetic film 23, which corresponds to the contact surface or attachment surface 24. A core with ferritic material, for example, would result in a smaller attraction force.

Surprisingly, the magnetic film 23 has no shielding effect for electromagnetic radio-frequency fields, for example at a frequency of 500 KHz. There is therefore no impediment to supplying the illumination means 15 via its coil 16 by means of a local radio-frequency magnetic field which is produced by the coil 14.

When using magnetic film 23, the contact pressure of the illumination means 15 on the attachment surface 24 is relatively high. In conjunction with the slightly plastic matrix material of the magnetic film 23, this results in sufficiently good thermal transfer between the illumination means 15 and the attachment surface 24. The dissipating cooling path into the comparatively solid material of the attachment surface 24 then has a low thermal resistance. A large proportion of the heat losses from the illumination means 15 can then be dissipated via the attachment surface 24.

In practice, the attachment surface 24 is preferably lodged with a large number of active feed circuits, whose RF magnetic field extends over the attachment surface 24 by about the width of a finger (up to a few cm, typically up to about 3 cm). Illumination modules which have been fitted can draw their electrical supply power therefrom. The physical principle behind this power transmission is preferably the weak resonant (magnetic) coupling of resonant circuits. When two resonant circuits oscillate synchronously, then a considerable amount of power can still be transmitted with a relatively low coupling degree. The low coupling degree allows a considerable distance of several cm between the two resonantly coupled resonant-circuit coils.

The lateral extent of the area with a feeding capability on the attachment surface 24 is limited to a few cm laterally beyond the coil 14 for each feed coil 14, for example up to 5 cm. However, the illumination means mount is not restricted to this and, in fact, other configurations can also be used, for example with a larger or smaller transmission coil, a higher or lower transmission power, more or fewer winding groups etc., thus making it possible to also reduce or increase the feed separation.

Depending on the arrangement areas can be excluded from the feed on the attachment surface 24, to be precise best of all close to the ends of that part of the magnet core 19 of the feed coil 14 which is in the form of a rod. This makes it possible to ensure that illumination modules 4, 5, 6, 15 can always remain on the attachment surface 24, to be precise even in the situation in which they are not intended to light up, or are intended to light up only weakly.

FIG. 4 shows a plan view of a sketch of the position of the coil 14 with the core 19 (shown by dashed lines) with respect to the coil 16 with the core 20 (solid line) from FIG. 3, with maximum power transmission (FIG. 4A) and minimum power transmission (FIG. 4B).

The RF magnetic field which passes through the attachment surface 24 is directed mainly parallel to the longitudinal axis of the feeding ferromagnetic (rod-type) core 19. If the receiving magnet core 20 in the form of a rod is aligned parallel to this, as is shown in FIG. 4A, this results in maximum coupling, and therefore also in the maximum power transmission.

If the receiving rod magnet core 20 is now rotated away from parallel alignment, the coupling falls sharply from about 45° and, on reaching 90°, as is shown in FIG. 4B, falls to virtually zero, and, with this, also the transmitted power. This coupling change, which is caused by rotation of the illumination means 15 and of its core 20, makes it possible to manually adjust the illumination power or the brightness of the illumination means 15 from a maximum value to zero.

The present invention is, of course, not restricted to the illustrated exemplary embodiments.

1. An illuminator comprising:
at least one receiver configured to wirelessly tapping off power from an alternating field; and
at least one light source which is connected to the receiver,
wherein the illuminator has a flat adhesive surface which is magnetic or can be magnetized.

2. The illuminator as claimed in claim 1, wherein the at least one light source is configured to tap off the electrical power via at least one coil.

3. The illuminator as claimed in claim 1,
wherein the receiver comprises at least one resonant circuit.

4. The illuminator as claimed in claim 1,
wherein the at least one light source has at least one light-emitting diode which is configured to emit white or colored light.

5. The illuminator as claimed in claim 1,
which is configured to be operated at at least one frequency in a frequency range between 100 KHz and 100 MHz.

6. The illuminator as claimed in claim 1,
wherein the receiver is sensitive to one direction of a field which is applied to it and is at least magnetic.

7. An illuminator mount comprising an attachment surface for attachment of an illuminator, the illuminator comprising at least one receiver configured to wirelessly tapping off power from an alternating field; and at least one light source which is connected to the receiver, wherein the illuminator has a flat adhesive surface which is magnetic or can be magnetized,
wherein the illuminator has at least one transmitter configured to emit an alternating field through the attachment surface, and has at least one magnetic film, whose magnetic surface represents the attachment surface.

8. The illuminator mount as claimed in claim 7, further comprising:
a plurality of transmitters which are distributed over a flat area.

9. The illuminator mount as claimed in claim 7,
whose attachment surface has at least one area which is fed by the at least one transmitter, and at least one area which is not fed.

10. The illuminator mount as claimed in claim 8,
wherein the frequency of the at least one transmitter is tunable.

11. The illuminator mount as claimed in claim 7,
wherein the at least one transmitter is configured to emit a directed alternating field.

12. The illuminator mount as claimed in claim 7,
wherein the at least one transmitter comprises has a resonant circuit.

13. The illuminator mount as claimed in claim 7,
wherein the transmitter is configured to be operated in a frequency range between 100 KHz and 100 MHz.

14. The illuminator mount as claimed in claim 7,
wherein the illuminator is supplied with power only up to a distance of 5 cm from the attachment surface.

15. A system, comprising:
at least one illuminator mount comprising an attachment surface for attachment of an illuminator, wherein the illuminator mount comprises
at least one transmitter configured to emit an alternating field through the attachment surface, and
at least one magnetic film, whose magnetic surface represents the attachment surface:,
and at least one illuminator at least one receiver configured to wirelessly tapping off power from an alternating field; and at least one light source which is connected to the receiver, wherein the illuminator has a flat adhesive surface which is magnetic or can be magnetized.

16. The illuminator as claimed in claim 5,
which is configured to be operated at at least one frequency in a frequency range between 100 KHz and 5 MHz.

17. The illuminator mount as claimed in claim 7,
wherein the magnetic film is flexible.

18. An illuminator mount comprising an attachment surface for attachment of an illuminator, wherein the illuminator mount comprises
at least one transmitter configured to emit an alternating field through the attachment surface, and
at least one magnetic film, whose magnetic surface represents the attachment surface.

19. The illuminator mount as claimed in claim 18,
wherein the magnetic film is flexible.

20. The illuminator mount as claimed in claim 8,
wherein the plurality of transmitters are arranged substantially parallel to the attachment surface.
